(19) United States
(12) Patent Application Publication
(10) Pub. No.: US 2025/0001931 A1
(43) Pub. Date: Jan. 2, 2025

(54) LIGHTBAR AND BEACON WARNING LIGHT

(71) Applicant: HiViz Lighting, Inc., Hendersonville, NC (US)

(72) Inventor: Samuel T. Massa, Hendersonville, NC (US)

(73) Assignee: HiViz Lighting, Inc., Hendersonville, NC (US)

(21) Appl. No.: 18/883,602

(22) Filed: Sep. 12, 2024

Related U.S. Application Data
(63) Continuation of application No. 18/639,229, filed on Apr. 18, 2024.
(60) Provisional application No. 63/497,153, filed on Apr. 19, 2023.

(51) Int. Cl. B60Q 1/52; B60Q 1/26; F21S 43/14; F21S 43/19; F21Y 115/10; H05B 47/11; H05B 47/155; H05B 47/165

(52) U.S. Cl. CPC B60Q 1/52; B60Q 1/2615; F21S 43/14; F21S 43/19; H05B 47/11; H05B 47/155; H05B 47/165; F21Y 2115/10

(57) ABSTRACT

A lighting system including an exoskeleton, a plurality of light modules coupled to the exoskeleton, a first corner light module, configured to couple to the exoskeleton, and a second corner light module configured to couple to the exoskeleton, wherein when the first corner light module and the second corner light module are coupled to the exoskeleton, an opening is formed. Further, a light system including a light bar comprising at least one light module, wherein the lighting system is configured to emit a flash pattern with two or more lighting elements on each of the at least one light module, and operate a command mode, wherein the command mode comprises emitting steady green light from the at least one light module.

### CROSS-REFERENCE(S) TO RELATED APPLICATION

This application is a division of U.S. patent application Ser. No. 18/639,229, filed Apr. 18, 2024, which claims the benefit of U.S. Provisional 63/497,153, filed Apr. 19, 2023, the entire disclosure of which is hereby incorporated by reference.

### BACKGROUND

Lighting systems are often used by vehicles, such as emergency vehicles. However, lighting systems have many issues. For example, conventional lighting systems tend to overheat. Conventional lighting systems tend also to accumulate water inside their housing or other cavities within the fixtures. Some conventional lighting systems are incapable of being utilized by vehicles of varying sizes. Further, some conventional lighting systems are difficult to service because they require the entire lighting system to be disassembled and potentially replaced if any component in the lighting system fails.

Accordingly, lighting systems that reduce overheating, can be integrated into vehicles of any sizes, and can be maintained without totally disassembling or replacing the entire lighting system are needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Disclosed herein is a lighting system including an exoskeleton including a first bar and a second bar, a plurality of light modules configured to couple to either the first bar or the second bar of the exoskeleton, a first corner light module, configured to couple a first side of the exoskeleton together, and a second corner light module configured to couple a second side of the exoskeleton together, where when the first corner light module and the second corner light module are coupled to the exoskeleton, an opening is formed between the first bar and the second bar.

Also disclosed herein is a lighting system including a light corner module shaped like a three-dimensional ellipse, and a corner module shaped like a three-dimensional ellipse, the corner module configured to couple to the light corner module, where when the light corner module and the second corner module are coupled, a circular opening is formed between the light corner module and the corner module.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1D are example lighting system, in accordance with the present technology;

FIGS. 2A-2F show various example lighting systems 100 having a plurality of light modules, in accordance with the present technology.

FIG. 3 is an exploded view of a light module, in accordance with the present technology;

FIGS. 4A-4B shows front side perspectives of a lighting element both, in accordance with the present technology;

FIG. 5 is an exploded view of a blank module, in accordance with the present technology;

FIG. 6 is an example lighting system having one or more attachment feet, in accordance with the present technology;

FIG. 7 is an example lighting system, in accordance with the present technology.

FIG. 8 is an example lighting system including one or more electrical modules or other track-mounted accessories, in accordance with the present technology;

FIG. 9 is an example lighting system in a night mode, in accordance with the present technology;

FIG. 10 is an example lighting system configured to display a battery level or water level of a vehicle, in accordance with the present technology; and

FIGS. 11A-11B show an example lighting system 100, in accordance with the present technology.

### DETAILED DESCRIPTION

While illustrative embodiments have been illustrated and described, it will be appreciated that various changes can be made therein without departing from the spirit and scope of the invention.

Described herein is a lighting system including an exoskeleton and a plurality of light modules. In some embodiments, the exoskeleton includes two bars, and the plurality of light modules couple to one of the two bars. In some embodiments, corner light modules couple the two bars together, forming an opening between the two bars.

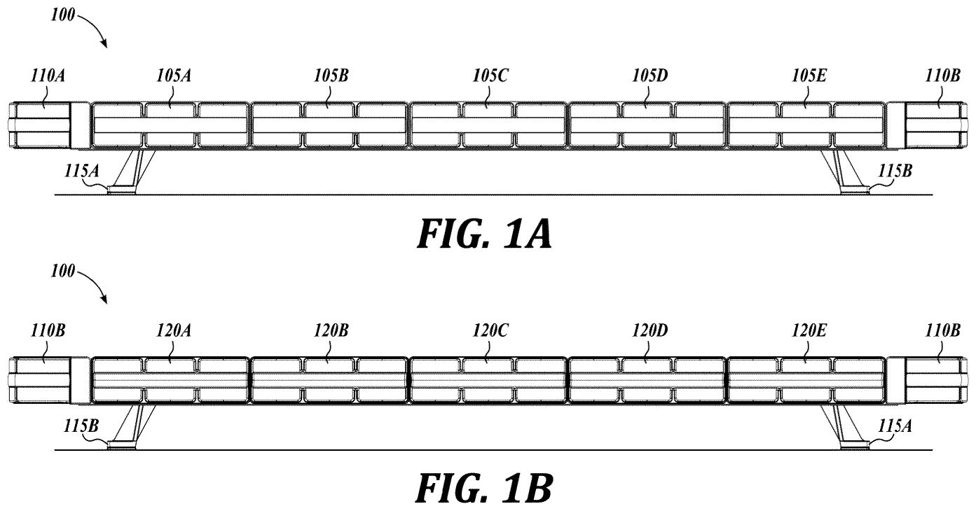

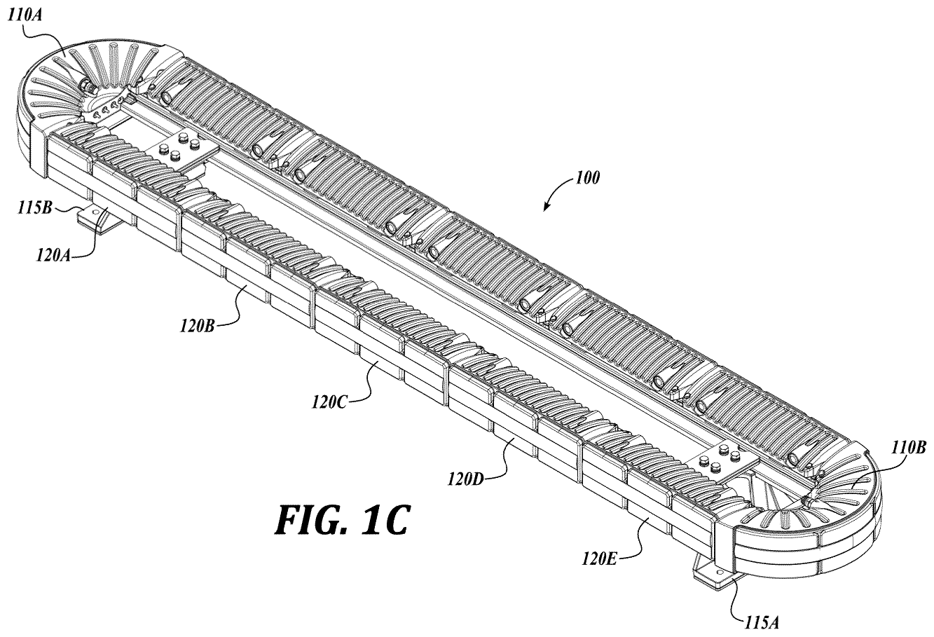

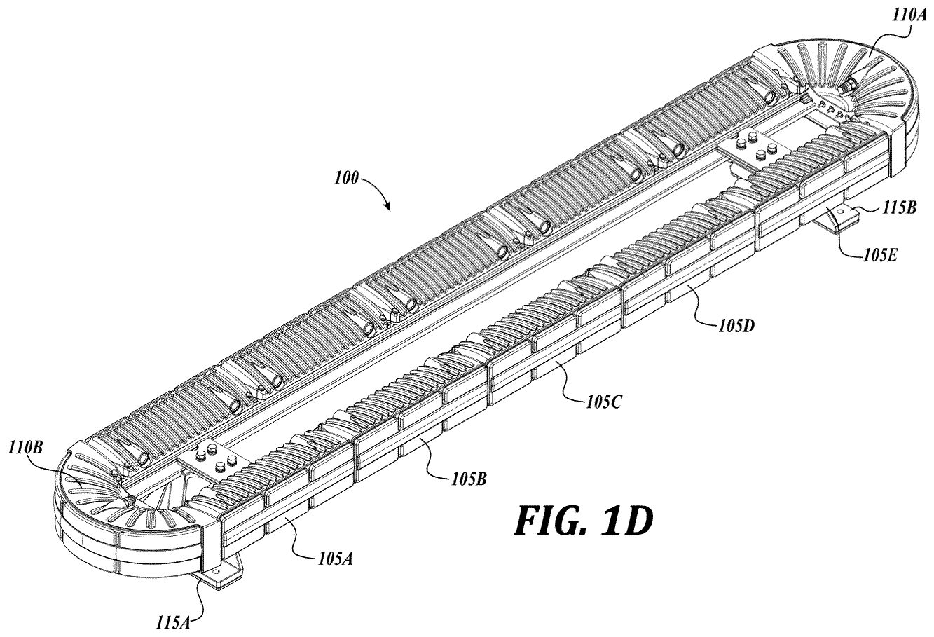

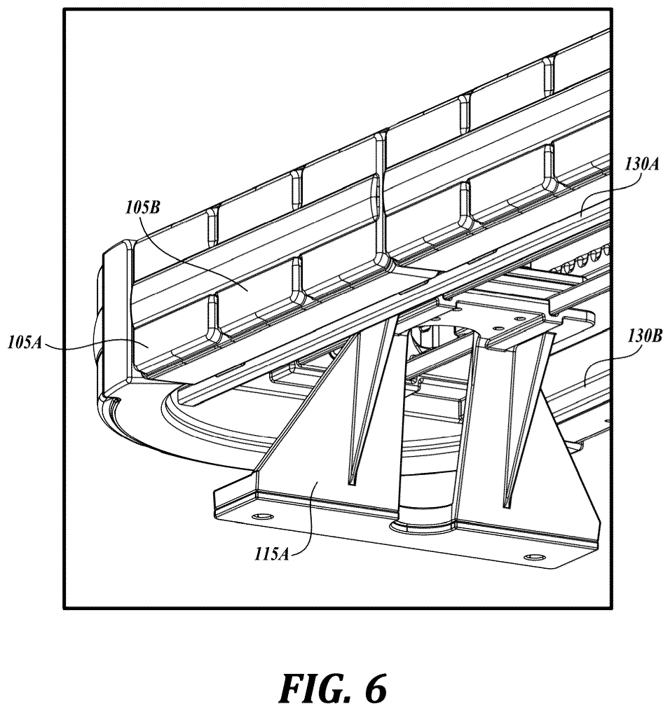

FIGS. 1A-1D are example lighting system 100, in accordance with the present technology. FIGS. 1A-1D shows front, rear, top front, and top rear perspectives of the lighting system 100, respectively. In some embodiments, the lighting system 100 includes an exoskeleton (as shown in FIG. 6). In some embodiments, the exoskeleton is a single, extruded bar. In some embodiments, the exoskeleton is a curved bar. In some embodiments, the exoskeleton includes a first bar and a second bar. In some embodiments, the exoskeleton is a track. In some embodiments, the exoskeleton includes any number of bars, including three, four, or five bars. The exoskeleton may take any number of forms capable of allowing a plurality of light modules, as described herein, to connect to the exoskeleton. In some embodiments, such as when there are two bars, the first bar and the second bar are of equal size. In some embodiments, the lighting system 100 does not include an exoskeleton.

In some embodiments, the lighting system 100 also includes a plurality of light modules 105A, 105B, 105C, 105D, 105E. In some embodiments, the plurality of light modules 105A, 105B, 105C, 105D, 105E are configured to couple to the exoskeleton. In some embodiments, the plurality of light modules 105A, 105B, 105C, 105D, 105E are free-standing, that it, not coupled to an exoskeleton. When the exoskeleton has two bars, the plurality of light modules 105A, 105B, 105C, 105D, 105E may connect to either the first bar or the second bar of the exoskeleton. In some embodiments, the lighting system further includes a first corner light module 110A, configured to couple a first side of the first bar and a first side of the second bar together, and a second corner light module 110B configured to couple a second side of the first bar and a second side of the second bar. In some embodiments, the first corner light module 110A and the second corner light module 110B are coupled to the exoskeleton, an opening is formed between the first bar and the second bar. In some embodiments, the lighting system takes the shape of a “donut,” such as shown in FIG. 1C. In some embodiments, the first corner light module 110A and the second corner light module 110B are shaped like three dimensional ellipses, as shown in FIG. 1C.

In some embodiments, the light modules and the corner light modules are configured to emit a flash pattern. In some embodiments, the light modules 105A, 105B, 105C, 105D, 105E and the corner light modules 110A, 110B are each controlled separately. As used herein, it should be understood that in some embodiments, each light module of the light modules 105A, 105B, 105C, 105D, 105E includes a separate controller. In other embodiments, a single controller controls all light modules 105A, 105B, 105C, 105D, 105E and the corner light modules 110A, 110B. In such embodiments, the controller can direct each of the light modules 105A, 105B, 105C, 105D, 105E and/or the corner light modules 110A, 110B independently, or in a group. For example, the controller may control some of the light modules, such as 105A and 105C as a group. One skilled in the art should understand that any number of the light modules 105A, 105B, 105C, 105D, 105E and/or the corner light modules 110A, 110B can be combined into one or more groups, which can be controlled together. In some embodiments, all the light modules 105A, 105B, 105C, 105D, 105E and the corner light modules 110A, 110B are controlled together.

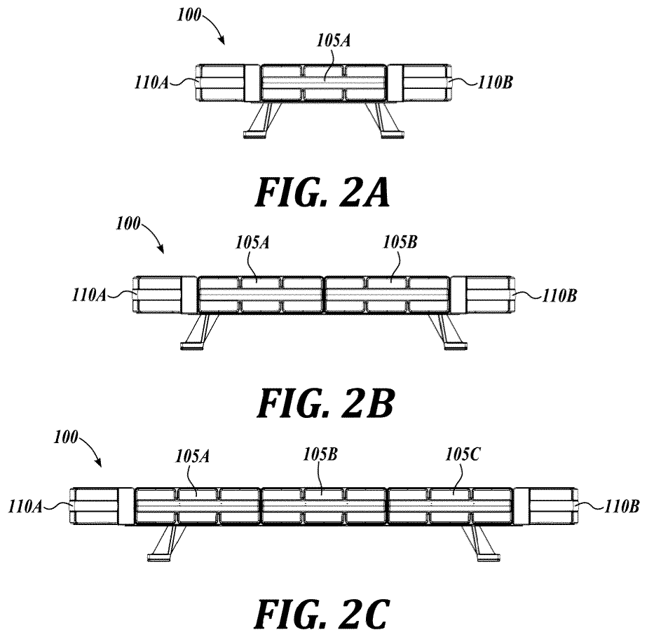

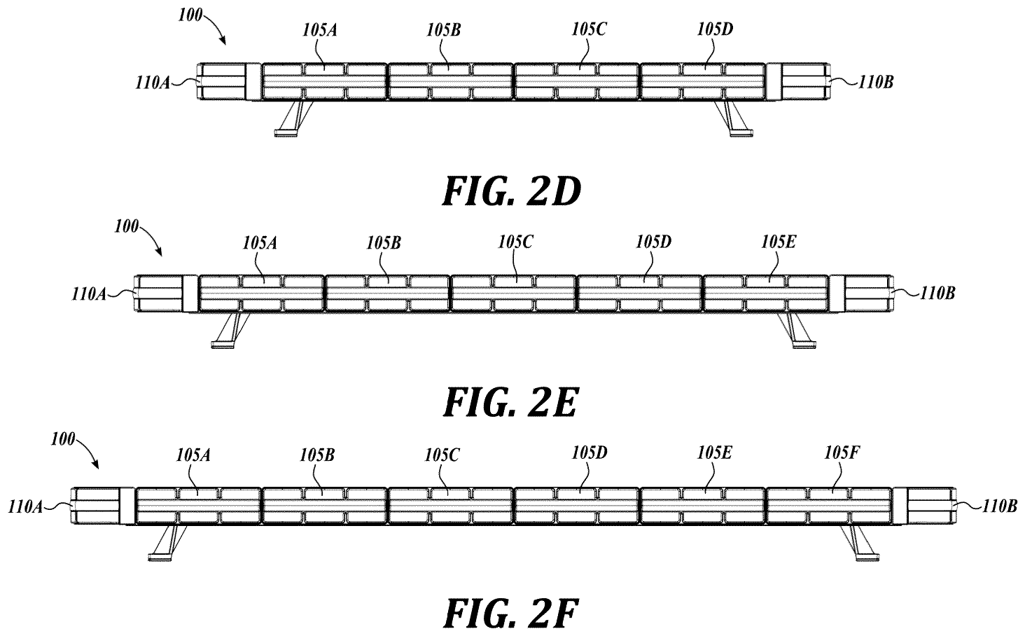

In some embodiments, the lighting system 100 includes one or more blank modules 120A, 120B, 120C, 120D, 120E. In some embodiments, the blank modules 120A, 120B, 120C, 120D, 120E face towards a back end of a vehicle or a back of the lighting system 100 as shown in FIG. 1B. In some embodiments, the plurality of light modules 105A, 105B, 105C, 105D, 105E face towards a front end of a vehicle, or a front of the lighting system 100, as shown in FIG. 1A. It should be understood that while five light modules 105A, 105B, 105C, 105D, 105E and five blank modules 120A, 120B, 120C, 120D, 120E are illustrated, any number of light modules and blank modules may be coupled to the exoskeleton, as shown in FIGS. 2A-2F. The number of light modules and the number of blank modules does not need to be equal. The lighting system is modular, so any number of light modules and blank modules could be coupled to the exoskeleton in any position, including alternating blank modules and light modules, and the like. In some embodiments, the blank modules may contain one or more electrical components, as shown herein.

FIGS. 2A-2F show various example lighting systems having a plurality of light modules (such as 105A, 105B, 105C, 105D, 105E in FIG. 1A), in accordance with the present technology. In some embodiments, each light module of the plurality of light modules is configured to be controlled independently. In some embodiments, the plurality of light modules is configured to emit a flash pattern. In some embodiments, the exoskeleton may be any length. In some embodiments, the first bar and/or the second bar may be any length. In this manner, any number of light modules (or blank modules) can be coupled with the two bars to form the lighting system as shown in FIG. 1.

For example, the plurality of light modules may include a single light module (FIG. 2A), two light modules (FIG. 2B), three light modules (FIG. 2C), four light modules (FIG. 2D), five light modules (FIG. 2E), or six light modules (FIG. 2F). In some embodiments, the lighting system is attached to a vehicle, as described herein. By allowing for any number of light modules in the plurality of light modules, the lighting system can be adjusted to fit in any location on any sort of vehicle. In some embodiments, the vehicle is a car, a truck, a plane, a train, or the like. In some embodiments, the vehicle is an emergency vehicle. In some embodiments, the vehicle is a firetruck.

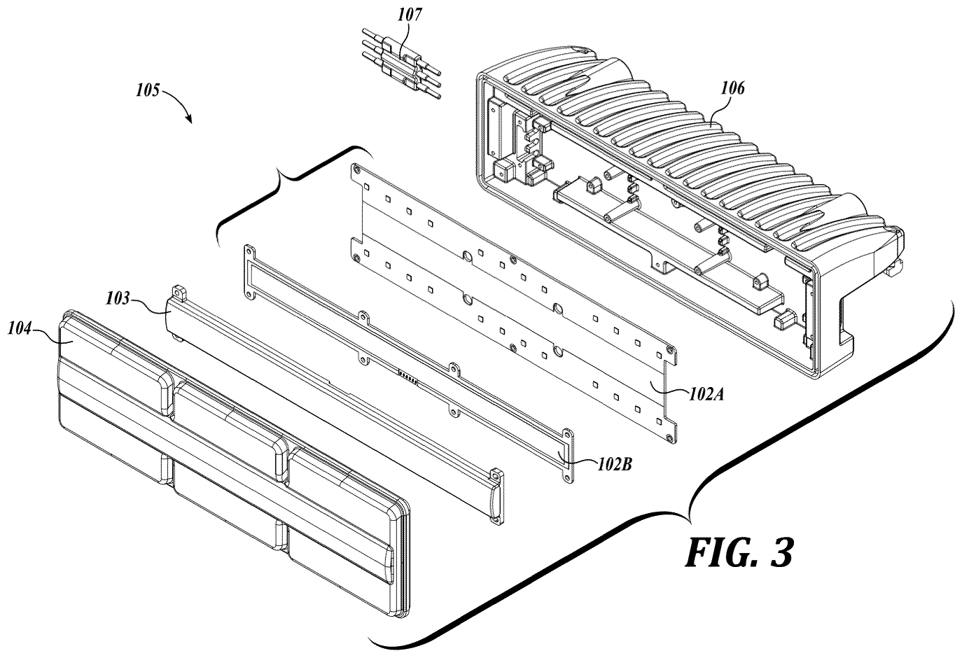

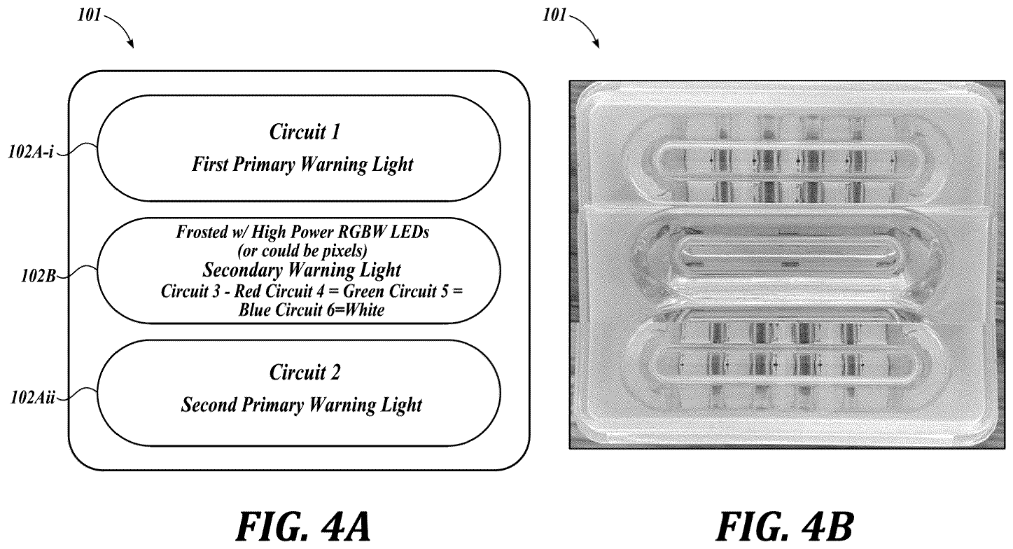

FIG. 3 is an exploded view of a light module 105, in accordance with the present technology. In some embodiments, each light module 105 of the plurality of light modules includes two or more light elements 101 in a housing 106. In some embodiments, the light element of the two or more light elements comprises a primary warning light 102A, and a secondary warning light 102B disposed between the light elements of the primary warning light 101A, as shown in detail in FIGS. 4A-4B.

In some embodiments, the secondary warning light 101A is configured to emit colored light. The secondary warning light 102B is configured to emit any color of light. In some embodiments, the secondary warning light 102B is controlled with an LED array. In some embodiments, the secondary warning light 102B is configured to emit red, green, blue, amber, or white light. In some embodiments, the secondary warning light 102B is a scattered light. In some embodiments, the secondary warning light 102B is a diffused light. In some embodiments, a diffused or scattered effect is added with a secondary warning light cover, such as secondary warning light cover 103. In some embodiments, the primary warning light may also include a primary warning light cover 104.

In some embodiments, the primary warning lights 102A are total internal reflection (TIR) lights. In some embodiments, the primary warning light 102A and the secondary warning light 102B are configured to emit light independently. In some embodiments, the primary warning light 102A and the secondary warning light 102B are controlled by a single controller. In some embodiments, the primary warning light 102A and the secondary warning light 102B on each light module 105 is controlled by a single controller. In some embodiments, the primary warning light 102A and the secondary warning light 102B are configured to emit a flash pattern. In some embodiments, the flash pattern is an emergency light flashing pattern. In some embodiments, the light module 105 further includes two or more interconnects 107. In some embodiments, the interconnects 107 have a number of pins, such as two or three pins. In some embodiments, the interconnects 107 are configured to connect the light module 105 to another light module of the plurality of light modules, or to a blank module of the plurality of blank modules, as shown in FIGS. 2A-2F.

FIG. 4A-4B shows frontside perspectives of a lighting element 101, in accordance with the present technology. As shown in FIG. 4A, in some embodiments, each light element 101 includes a first primary warning light 102A-i, a second primary warning light 102A-ii, and a secondary warning light 102B disposed between the first primary warning light 102A-i and the second primary warning light 102A-ii. In some embodiments, each light element includes a cover (as shown in FIG. 3). In some embodiments, a portion of the cover that protects the secondary warning light (such as 103) is a milky or frosted material. In some embodiments, the milky or frosted material diffuses the colored light emitted from the secondary warning light.

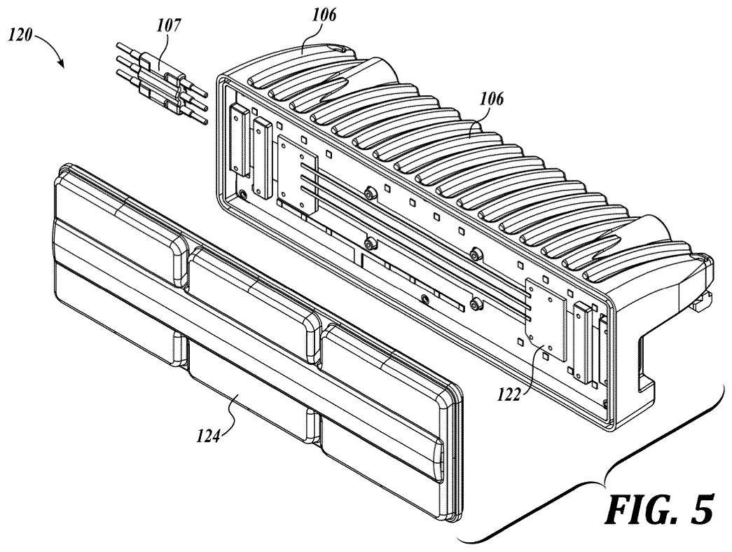

FIG. 5 is an exploded view of a blank module 120, in accordance with the present technology. In some embodiments, the lighting system (such as lighting system 100) further comprises one or more blank modules 120 configured to be coupled to the exoskeleton (such as the first bar or the second bar as shown in FIG. 6). In some embodiments, the blank modules 120 are coupled to one of the first bar or the second bar at the rear of the lighting system.

In some embodiments, the blank modules 120 further include two or more main power printed circuit boards (PCBs) with connecting wires 122. In some embodiments, the blank modules include additional hardware to connect to the light modules. In some embodiments, at least one of the one or more blank modules houses one or more electrical components, such as one or more optical sensors, one or more humidity sensors a network interface; components capable of facilitating a local area network (LAN), Bluetooth, controller area network (CAN), Wi-Fi, or other wireless connection, a controller, a battery, one or more wires, light detection and ranging (LiDAR), radar, other distance sensing devices, cameras, and the like.

In some embodiments, the blank module 120 further includes two or more interconnects 127. In some embodiments, the interconnects have a number of pins, such as two or three pins. In some embodiments, the interconnects are configured to connect the blank module 120 to another blank module of the plurality of blank modules, or to a light module of the plurality of light modules. In some embodiments, each blank module 120 further includes a cover 124.

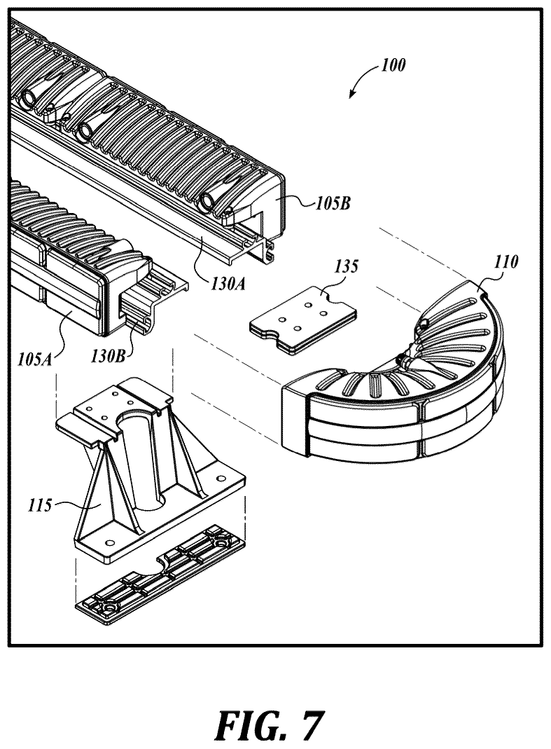

FIG. 6 is an example lighting system 100 having one or more attachment feet 115A, 115B and an exoskeleton 130 including a first bar 130A and a second bar 130B, in accordance with the present technology. In some embodiments, the lighting system is configured to be attached to a vehicle. In some embodiments, the lighting system further includes one or more attachment feet 115A, 115B configured to couple to the first bar 130A and the second bar 130B in the opening between the first bar 130B and the second bar 130B, where the one or more attachment feet 115A, 115B are configured to attach the lighting system to the vehicle. In some embodiments, the attachment feet 115A, 115B can be clamped onto the first and second bar 130A, 130B with one or more connections (such as shown in FIG. 7).

FIG. 7 is an example lighting system, in accordance with the present technology. In some embodiments, the light corner modules 110 are configured to couple the first bar 130A and the second bar 130B of the exoskeleton together. As shown in FIG. 7, the corner light modules 110 may have a female connection configured to couple to the first bar 130A and the second bar 130B. In some embodiments, the interconnects (such as interconnects 107, 127) of the blank modules, light modules 105A, 105B, or the light corner modules may work to electrically couple the light corner module 110 to adjacent light modules 105A, 105B, blank modules, or light modules and blank modules.

In some embodiments, the attachment feet 115A, 115B couple to the exoskeleton with one or more connections 135. In some embodiments, the connections 135 are clamps, grooves, or the like. In some embodiments, the attachment feet 115A, 115B may be slid along the two bars 130A, 130B to adjust the placement of the attachment feet. In this manner, the lighting system can be modified to attach to any size vehicle or in any location of the vehicle, regardless of the size of the two bars of the exoskeleton.

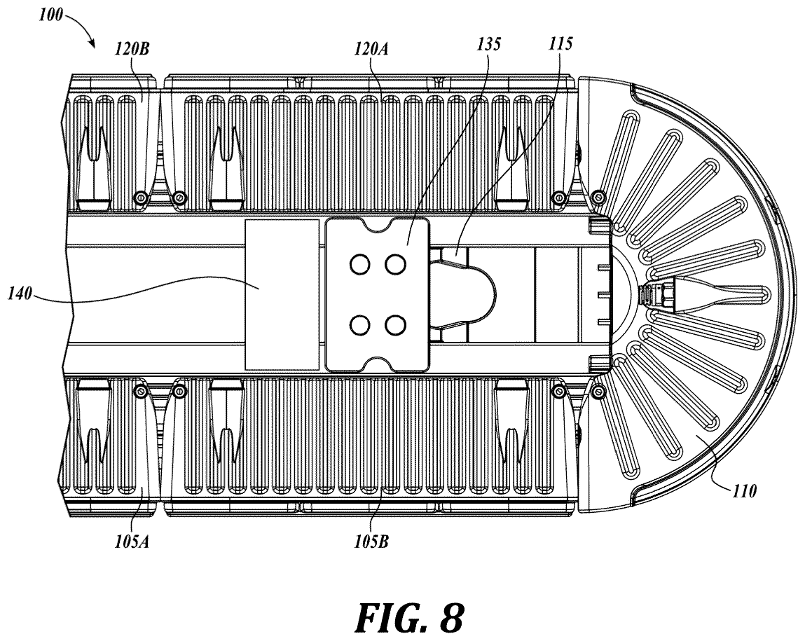

FIG. 8 is an example lighting system 100 including one or more electrical modules 140, in accordance with the present technology. In some embodiments, the lighting system 100 further includes one or more electrical modules 140 configured to couple to the first bar 130A and the second bar 130B in the opening between the first bar 130A and the second bar 130B. In some embodiments, the one or more electrical modules 140 include one or more optical sensors, or one or more circuit modules.

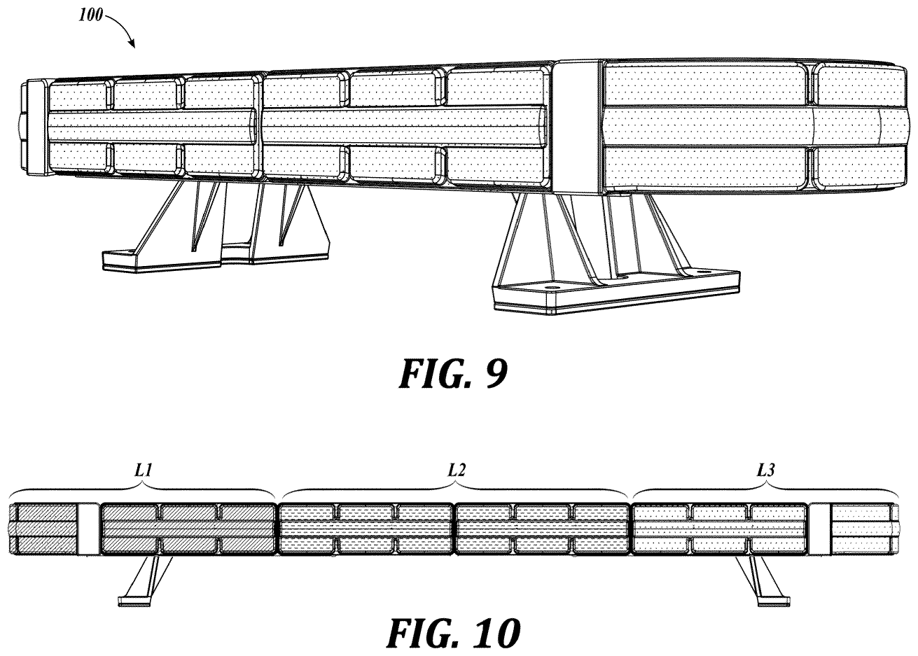

FIG. 9 is an example lighting system 100 in a command mode, in accordance with the present technology. In some embodiments, the command mode indicates a commander of a response or emergency situation. In some embodiments, the command mode comprises emitting green light from the plurality of light modules. While no color is shown in FIG. 9, it should be understood that all light modules (including the corner modules) emit a green light in command mode. U.S. Provisional 63/497,153, which the present application claims the benefit of and is hereby incorporated by reference shows the green color of the command mode. In some embodiments, the green light is constant (or “steady”) light that does not flash, but in some embodiments, the green light may flash.

In some embodiments, at least one light module of the plurality of light modules comprises a common optical element configured to emit red, green, blue, amber, and white light. In some embodiments, the common optical element is a five color LED circuit. In some embodiments, the five color LED circuit uses five single independent LEDs. In some embodiments, the five color LED circuit includes four pixels and a 5th primary color. In some embodiments, the five colors are selected from blue, red, amber, green, and white color light.

In some embodiments, every light module of the plurality of light modules is capable of emitting red, green, blue, amber, and white light. In some embodiments, the red, green, blue, amber, and white light are colors that are compliant with the Society of Automotive Engineers (SAE) standard J 578-2020. In order to comply with SAE standards, the colored light may be chromatically accurate. In some embodiments, in order to comply with SAE standards, individual LEDs are used to emit chromatically accurate colored light.

Conventionally, emergency lights may have light modules which can be disposed adjacent to one another to create a light bar that emits five colors. In some conventional emergency lighting systems, the modules may be able to emit three colors, or rarely, four colors. For example, one light module may be able to emit red, blue, or white light.

In contrast, the lighting system 100 disclosed herein is capable of emitting any color light from any light module of the plurality of light modules. In some embodiments, each light module of the plurality of light modules is capable of emitting red, green, blue, amber, and white light. Further, the plurality of light modules may also emit a combination of any of red, green, blue, amber, and white light. In some embodiments, the plurality of light modules are further configured to emit infrared (IR) light.

In some embodiments, when in command mode, one or more additional lights, separate from the lighting system 100 also emit a steady green light. As used herein, the term “additional lights” includes lights of a vehicle and standalone lights separate from lighting system 100.

In some embodiments, the lighting system further includes a night mode. In some embodiments, the one or more optical sensors are configured to measure ambient light and switch the lighting system to the mode when the ambient light falls below a predetermined threshold. In some embodiments, two optical sensors are located in the light corner modules as described herein. In some embodiments, the two optical sensors face into the opening of the lighting system as described herein. In operation, the light system compares the measurements of the two optical sensors, references the light from the lighting system, and omits the light generated by the lighting system. In some embodiments, this is accomplished by taking ambient light measurements during a break in a flashing pattern of the lighting system. In this manner, the lighting system can avoid a false positive trigger for night mode based on the lighting system itself. In some embodiments, the night mode includes dimming the plurality of light modules in the lighting system. In some embodiments, the night mode further includes dimming any number of lights on the vehicle. In some embodiments, the lighting system can direct a number of remote lights to dim while in night mode.

In some embodiments, the one or more optical sensors are configured to sense light and adjust the plurality of light modules on the lighting system, the lights on the vehicle, or a combination thereof to dim in a gradient based on the ambient light. In this manner, the lighting system can direct the light fixtures to dim based on any time or type of day or night, including direct sunlight, overcast, cloudy, rainy, dusk, twilight, dawn, and the like.

FIG. 10 is an example lighting system configured to display a battery level or water level of a vehicle, in accordance with the present technology. In some embodiments, the plurality of light modules is configured to display a battery level or a water level of the vehicle. In some embodiments, L1, L2, and L3 represent different colors of light. In some embodiments, L1 is red, L2 is yellow, and L3 is green. In some embodiments, by emitting different colors of light, a battery level or water level of the vehicle is displayed. For example, if the battery is half charged, the lighting system may emit half yellow light and half green light. In some embodiments, each color group of lights (such as shown emitting the colors L1, L2, L3) represents a different state of the vehicle. For example, the light modules emitting color L1 may represent a group reflecting the battery level. If the battery is dead (5% or less), these modules may emit red, if it is at a first threshold of charge (such as 25%), yellow, and if the battery is at a second threshold of charge (such as 75% or more), green.

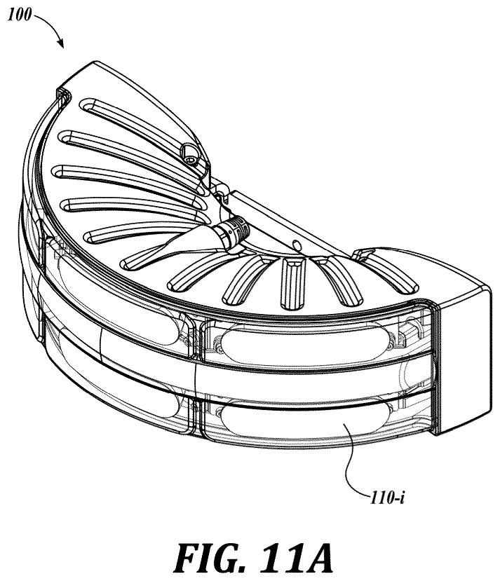

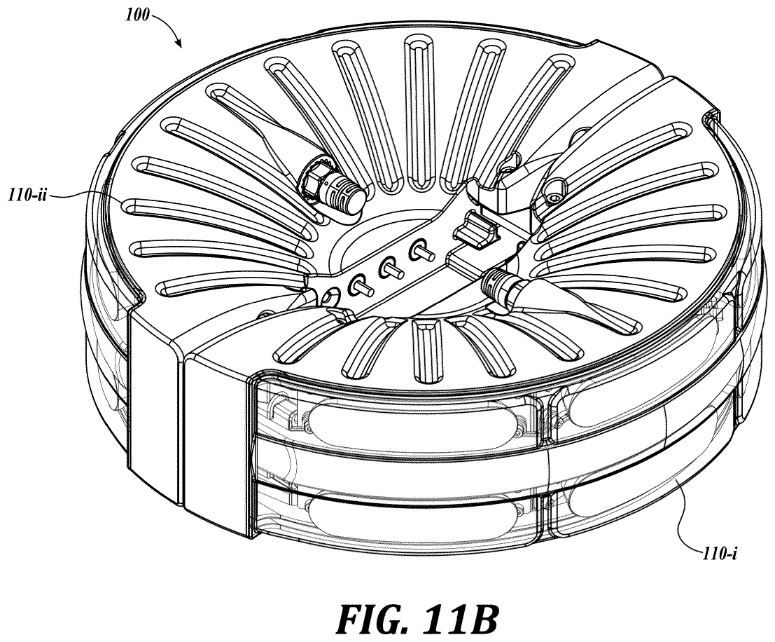

In some embodiments, the lighting system further includes one or more additional lights, where the one or more additional lights are remote from the exoskeleton, and where the one or more additional lights are controlled by the lighting system. For example, in some embodiments, the one or more additional lights may be integrated into a vehicle, such as headlights, undercarriage lights, or scene lights. In such embodiments, the lighting system may direct the remote lights to turn on, flash, dim, or the like with the light modules on the lighting system. In some embodiments, the lighting system can direct the remote lights independently of the light modules on the lighting system. In some embodiments, the controller for the remote lights is housed inside one or more of the light corner modules. An example additional light is also shown in FIG. 11.

FIGS. 11A-11B show an example lighting system 100, in accordance with the present technology. In some embodiments, the lighting system 100 is a lighting beacon. In another aspect, disclosed herein is a lighting system including a light corner module 110-i shaped like a three-dimensional ellipse and a corner module 110-ii shaped like a three-dimensional ellipse. In some embodiments, the corner module 110-ii is configured to couple to the light corner module 110-i. In some embodiments, when the light corner module 110-i and the second corner module 110-ii are coupled, a circular opening is formed between the light corner module 110-i and the corner module 110-ii, as shown in FIG. 11B. In some embodiments, the corner module 110-ii is a blank corner module. In some embodiments, the light corner module 110-i is a first light corner module and the corner module 110-ii is a second light corner module.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

The embodiments of the invention in which an exclusive property or privilege is claimed are defined as follows:

1. An emergency lighting system comprising:
a light bar comprising at least one light module, wherein the at least one light module comprises a common optical element configured to emit red, green, blue, amber, and white light.

2. The emergency lighting system of claim 1, wherein the at least one light module is further configured to emit infrared (IR) light.

3. The emergency lighting system of claim 1, wherein the common optical element comprises a five-color light-emitting diode (LED) circuit.

4. The emergency lighting system of claim 1, wherein the common optical element comprises five independent light emitting diodes (LEDs).

5. The emergency lighting system of claim 1, wherein the common optical element comprises four pixels and a fifth primary color.

6. The emergency lighting system of claim 1, wherein the common optical element is further configured to emit combinations of red, green, blue, amber, and white light.

7. The emergency lighting system of claim 1, wherein the one or more optical sensors are configured to:
measure ambient light; and
switch the lighting system to night mode when the ambient light falls below a predetermined threshold.

8. The emergency lighting system of claim 1, wherein the lighting system further includes:
one or more additional lights, wherein the one or more additional lights are remote from the light bar, wherein the one or more additional lights are controlled by the lighting system, and wherein the one or more additional lights are configured to emit red, green, blue, amber, and white light.

9. The emergency lighting system of claim 1, wherein each light module of the at least one light module comprises:
two or more light elements, wherein each light element of the two or more light elements comprises:
a first primary warning light;
a second primary warning; and
a secondary warning light.

10. The emergency lighting system of claim 1, wherein the at least one light module is one light module of a plurality of light modules, and the lighting system further comprises:
an exoskeleton, wherein the plurality of light modules coupled to the exoskeleton;
a first corner light module, configured to couple to the exoskeleton; and
a second corner light module configured to couple to the exoskeleton, wherein when the first corner light module and the second corner light module are coupled to the exoskeleton, an opening is formed.

11. The emergency lighting system of claim 10, wherein each light module of the plurality of light modules is configured to be controlled independent of another light module of the plurality of light modules.

12. The emergency lighting system of claim 10, wherein the plurality of light modules is configured to emit a flash pattern.

13. The emergency lighting system of claim 10, wherein each light module of the plurality of light modules comprises two or more light elements, wherein each light element of the two or more light elements comprises:
a first primary warning light; and
a secondary warning light.

14. The emergency lighting system of claim 13, wherein the secondary warning light element is configured to emit red, green, blue, amber, white light, infrared light, or a combination thereof.

15. The emergency lighting system of claim 13, wherein the two or more lighting elements further comprise a second primary warning light.

16. The emergency lighting system of claim 15, wherein the first primary warning light and the second primary warning light are configured to emit light independently.

17. The emergency lighting system of claim 15, wherein the first primary warning light, the second primary warning light, the secondary warning light, or a combination thereof are configured to emit a flash pattern.

18. An emergency lighting system, comprising:
a light bar; and
one or more additional lights, wherein the one or more additional lights are controlled by the lighting system, and wherein the one or more additional lights comprise a common optical element configured to emit red, green, blue, amber, and white light.

19. The emergency lighting system of claim 18, wherein the one or more additional lights are selected from headlights, undercarriage lights, scene lights, standalone lights separate from the emergency lighting system, or a combination thereof.

20. The emergency lighting system of claim 18, wherein the common optical element is further configured to emit combinations of red, green, blue, amber, and white light.
